(19) United States
(12) Patent Application Publication
(10) Pub. No.: US 2020/0067945 A1
(43) Pub. Date: Feb. 27, 2020

(54) BOTNET MITIGATION

(71) Applicant: Charter Communications Operating, LLC, St. Louis, MO (US)

(72) Inventors: Richard Compton, Highlands Ranch, CO (US); Pratik Lotia, Denver, CO (US)

(21) Appl. No.: 16/113,873

(22) Filed: Aug. 27, 2018

(51) Int. Cl. H04L 29/06

(52) U.S. Cl. CPC H04L 63/145; H04L 2463/144; H04L 63/1416; H04L 63/02

(57) ABSTRACT

Systems, methods, and devices of the various embodiments may enable the mitigation of malicious botnets. Various embodiments may block communication of malicious botnets from customer computing devices to malicious command and control (C2) servers. Various embodiments may include mitigating botnets in a network by diverting Internet traffic bound for a malicious C2 server to a botnet mitigation controller of the network. In various embodiments, diverting Internet traffic may include programmatically injecting Border Gateway Protocol (BGP) routes in a network to route Internet traffic bound for a malicious C2 server to a botnet mitigation controller of the network. In various embodiments, a botnet mitigation controller may determine whether diverted Internet traffic is malicious and may handle malicious diverted Internet traffic according to one or more security settings.

### BACKGROUND

Network operators, such as Internet Service Providers (ISPs), continually face the threat of the computing devices of the network users being hijacked for use in malicious botnets. In a malicious botnet, a malicious attacker uses malware, such as keyloggers, ransomware, etc., on computing devices to control the malware infected computing devices and the computing devices' connections to the network and Internet. The infected computing devices in the malicious botnet typically communicate with a command and control (C2) server of the malicious attacker directing the infected computing devices to perform various malicious tasks, such as extracting financial information from the infected computing devices, extracting health information from the infected computing devices, extracting personal information from the infected computing devices, causing the infected computing devices to participate in a denial of service attack, etc.

### SUMMARY

The systems, methods, and devices of the various embodiments disclosed herein may enable the mitigation of malicious botnets. Various embodiments may include a method of mitigating botnets in a network, such as a network of an Internet Service Provider (ISP). The method may be implemented in a computing device of the network, such as a botnet mitigation controller server, traffic inspection server, etc. The method may include inspecting diverted Internet traffic associated with a threat location to identify one or more attributes of the diverted Internet traffic. The diverted Internet traffic may be outbound Internet traffic diverted in response to an indication that the outbound Internet traffic is associated with the threat location. The method may include determining whether the diverted Internet traffic is malicious based at least in part on the identified one or more attributes. The method may include handling the diverted Internet traffic according to one or more security settings in response to determining that the diverted Internet traffic is malicious.

Further embodiments disclosed herein include a computing device having a processor configured with processor-executable instructions to perform operations of the methods summarized above. Further embodiments disclosed herein include a computing device including means for performing functions of the methods summarized above. Further embodiments disclosed herein include a non-transitory processor-readable storage medium having stored thereon processor-executable instructions configured to cause a computing device processor to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a communication system block diagram of an IP network suitable for use with various embodiments.

FIG. 2 is a process flow diagram illustrating an embodiment method for identifying potentially malicious Internet traffic.

FIG. 3A is a process flow diagram illustrating an embodiment method for mitigating botnets.

FIG. 3B is a process flow diagram illustrating another embodiment method for mitigating botnets.

FIG. 4A is a process flow diagram illustrating an embodiment method for handling malicious diverted Internet traffic according to one or more security settings.

FIG. 4B is a process flow diagram illustrating another embodiment method for handling malicious diverted Internet traffic according to one or more security settings.

FIG. 5 is a component diagram of an example computing device suitable for use with various embodiments.

FIG. 6 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, the term “computing device” is used to refer to any one or all of satellite or cable set top boxes, laptop computers, rack mounted computers, routers, cable modem termination systems (CMTSs), cellular telephones, smart phones, personal or mobile multi-media players, personal data assistants (PDAs), personal computers, tablet computers, smart books, palm-top computers, desk-top computers, wireless electronic mail receivers, multimedia Internet enabled cellular telephones, wireless gaming controllers, streaming media players (such as, ROKU™), smart televisions, digital video recorders (DVRs), modems, and similar electronic devices which include a programmable processor and memory and circuitry for providing the functionality described herein.

The various embodiments are described herein using the term “server” to refer to any computing device capable of functioning as a server, such as communications server, a name server, a master exchange server, web server, mail server, document server, database server, route server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as a server only to the extent necessary to provide the functionality described herein.

Network operators, such as Internet Service Providers (ISPs), continually face the threat of the computing devices of the network users being hijacked for use in malicious botnets. In a malicious botnet, a malicious attacker uses malware, such as keyloggers, ransomware, etc., on computing devices to control the malware infected computing devices and the computing devices' connections to the network and Internet. The malware infected computing devices in the malicious botnet typically communicate with a command and control (C2) server of the malicious attacker directing the malware infected computing devices to perform various malicious tasks. These malicious tasks may include malicious data extraction (e.g., unauthorized financial data extraction, unauthorized health data extraction, unauthorized personal information extraction, etc.), directing the computing device to participate in attacks (e.g., ransomware attacks, malware attacks, zombie attacks, distributed denial of service (DDoS) attacks, etc.), directing the computing device to conduct unauthorized bitcoin mining, etc.

The systems, methods, and devices of the various embodiments disclosed herein may enable the mitigation of malicious botnets. Various embodiments may provide for botnet mitigation by proactively and/or reactively blocking communication of malicious botnets from residential customer computing devices to malicious C2 servers. Various embodiments may include a method of mitigating botnets in a network, such as a network of an ISP, by diverting Internet traffic bound for a malicious C2 server to a botnet mitigation controller of the network based on data from a botnet detection tool of the network and/or a third-party threat intelligence service. In various embodiments, diverting Internet traffic may include programmatically injecting Border Gateway Protocol (BGP) routes in a network, such as a network of an ISP, to route Internet traffic bound for a malicious or potentially malicious C2 server to a botnet mitigation controller of the network. In various embodiments, a botnet mitigation controller of a network may determine whether diverted Internet traffic is malicious and may handle malicious diverted Internet traffic according to one or more security settings.

Various embodiments may enable the identification of potentially malicious Internet traffic. In various embodiments, a computing device of a network, such as botnet threat detector server, botnet mitigation controller server, and/or route reflector may operate as a monitoring device to detect outbound Internet traffic associated with a threat location. The computing device may be a computing device of a network, such as a network of an ISP, running a virtual machine or other type container performing operations to detect outbound Internet traffic associated with a threat location. A threat location may be an Internet destination associated with a malicious C2 server, such as an Internet Protocol (IP) address of a malicious C2 server, a domain associated with a malicious C2 server, etc. Threat locations may be identified by botnet detection tools of the network and/or a third-party threat intelligence service providing listings of known (or suspected) malicious C2 servers, such as listings of known (or suspected) malicious C2 server IP addresses, listings of known (or suspected) malicious C2 server domains, etc. Listings of known (or suspected) threat locations may be updated as information about malicious C2 servers associated with botnets is obtained from botnet detection tools of the network and/or a third-party threat intelligence service. The listings of known (or suspected) threat locations may operate as a blacklist for the network causing any outbound Internet traffic destined for the listed threat locations to be diverted. The listings of known (or suspected) threat locations may be changed and/or modified by the network operator, such as to add, remove, and/or modify threat locations. In various embodiments, the computing device may monitor domain name service (DNS) lookups for outbound Internet traffic. For example, the computing device may monitor DNS lookups by tapping netflows in a network or by monitoring DNS lookup logs. As a specific example, the computing device may run a Python script which is continuously listening for the IP addresses of known (or suspected) threat locations in DNS lookups.

In various embodiments, the computing device of the network may determine whether the DNS lookups are associated with a threat location. For example, the computing device may compare the IP addresses or domains in the DNS lookups to listings of known (or suspected) threat locations identified by botnet detection tools of the network and/or a third-party threat intelligence services to determine whether the DNS lookups are associated with a known (or suspected) threat location. DNS lookups associated with such a threat location may indicate that a computing device of the network is attempting to communicate to that threat location over the Internet and will send Internet traffic to that threat location. In response to a DNS lookup being associated with a threat location (e.g., a DNS lookup corresponding to an IP address of a known malicious C2 server, etc.), the computing device may send an indication of outbound Internet traffic for the DNS lookup associated with the threat location. The indication of the outbound Internet traffic for the DNS lookup associated with the threat location may be a message indicating that a computing device of a network is attempting to send outbound Internet traffic from the network to an IP address and/or a domain associated with a threat location. The indication of the outbound Internet traffic for the DNS lookup associated with the threat location may include the IP address and/or domain of the threat location.

In various embodiments, a computing device of a network, such as a botnet mitigation controller server, and/or a route reflector may divert Internet traffic outbound to a threat location and inspect the diverted Internet traffic to determine whether the diverted Internet traffic is malicious or not. The computing device may be a computing device of a network, such as a network of an ISP, running a virtual machine or other type container performing operations to divert and inspect Internet traffic outbound to a threat location. In various embodiments, the computing device may receive an indication of outbound Internet traffic for the DNS lookup associated with the threat location. The indication of the outbound Internet traffic for the DNS lookup associated with the threat location may be a message indicating that a computing device of a network is attempting to send outbound Internet traffic from the network to an IP address and/or a domain associated with a threat location. The indication of the outbound Internet traffic for the DNS lookup associated with the threat location may include the IP address and/or domain of the threat location. In response to receiving an indication of outbound Internet traffic for the DNS lookup associated with the threat location, the computing device may divert Internet traffic intended for the threat location. In various embodiments, diverting Internet traffic intended for the threat location may include generating and sending a BGP update indicating a more specific BGP route for the threat location, e.g., a /32 route for the threat location, to a route reflector of the network. The BGP update indicating a more specific BGP route for the threat location may indicate a computing device (e.g., the botnet mitigation controller server, traffic inspection server, etc.) that is in the path to use for outbound Internet traffic addressed to the threat location. In various embodiments, the BGP update indicating a more specific BGP route for the threat location may be a BGP Flow Specification (BGP Flowspec) update. The route reflector may push the BGP update indicating a more specific BGP route for the threat location, e.g., a /32 route for the threat location, to routers in the network, such as customer edge routers in the network backbone, other routers of the network, etc. In response to receiving the BGP update indicating a more specific BGP route for the threat location, e.g., a /32 route for the threat location, the routers in the network, such as customer edge routers in the network backbone, other network routers, etc., may route all outbound Internet traffic from customer computing devices addressed to the threat location to the computing device (e.g., the botnet mitigation controller server, the threat inspection server, etc.). In this manner, all outbound Internet traffic from customer computing devices addressed to (i.e., intended for) the threat location may be diverted to the computing device (e.g., the botnet mitigation controller server, the threat inspection server, etc.).

In various embodiments, the computing device of the network (e.g., the botnet mitigation controller server, the threat inspection server, etc.) may receive the diverted Internet traffic and inspect the diverted Internet traffic to identify one or more attributes of the diverted Internet traffic. In various embodiments, inspecting the diverted Internet traffic to identify one or more attributes of the diverted Internet traffic may include performing deep packet inspection on the diverted Internet traffic. The attributes of the diverted Internet traffic identified by the inspection may include the type of data in the packets of the diverted Internet traffic, the format of data in the packets of the diverted Internet traffic, values of data in the packets of the diverted Internet traffic, etc.

In various embodiments, the computing device (e.g., the botnet mitigation controller server, the threat inspection server, etc.) may determine whether the diverted Internet traffic is malicious based at least in part on the identified one or more attributes of the diverted Internet traffic. For example, the computing device may compare the one or more attributes of the diverted Internet traffic to attributes of known malicious botnet traffic and in response to the one or more attributes matching an attribute of known malicious botnet traffic may determine that the diverted Internet traffic is malicious. As another example, the computing device may compare the one or more attributes of the diverted Internet traffic to attributes of known malicious botnet traffic and in response none of the attributes matching an attribute of known malicious botnet traffic may determine that the diverted Internet traffic is not malicious. In response to determining that the diverted Internet traffic is not malicious, the computing device (e.g., the botnet mitigation controller server, the threat inspection server, etc.) may route the diverted Internet traffic toward its original destination. As some IP addresses, especially IP version 4 (IPv4) addresses, may be shared by multiple computing devices, not all Internet traffic destined for a suspected threat location may actually be malicious. As such, in various embodiments, when the Internet traffic is determined to not be malicious, the Internet traffic may be routed toward its intended original destination.

In various embodiments, in response to determining that the diverted Internet traffic is malicious, the computing device (e.g., the botnet mitigation controller server, the threat inspection server, etc.) may handle the diverted Internet traffic according to one or more security settings. Handling the diverted Internet traffic according to one or more security settings may include dropping packets of the malicious Internet traffic, sending packets of the malicious Internet traffic to a firewall for further inspection, etc.

In various embodiments, the computing device (e.g., the botnet mitigation controller server, the threat inspection server, etc.) may determine whether diverted Internet traffic for a threat location meets a whitelist condition. For example, a whitelist condition may be a number of times that diverted Internet traffic for a threat location is determined to not be malicious. Diverted Internet traffic for a threat location being found malicious a selected number of times may indicate that the threat location is not actually malicious. In response to determining that the diverted Internet traffic for a threat location meets a whitelist condition, the computing device (e.g., the botnet mitigation controller server, the threat inspection server, etc.) may undivert the Internet traffic for the threat location. In various embodiments, undiverting Internet traffic for the threat location may include generating and sending a BGP withdraw (e.g., a BGP Flowspec withdraw, etc.) removing the more specific BGP route for the threat location previously added for the threat location, e.g., canceling the /32 route for the threat location, to a route reflector of the network. The BGP withdraw canceling the more specific BGP route for the threat location may effectively remove the computing device itself (e.g., the botnet mitigation controller server, the threat inspection server, etc.) from the path to the threat location. The route reflector may push the BGP withdraw removing the more specific BGP route for the threat location to routers in the network, such as customer edge routers in the network backbone, other network routers, etc. In response to receiving the BGP withdraw removing the more specific BGP route for the threat location the routers in the network, such as customer edge routers, other routers, etc., may route all outbound Internet traffic from customer computing devices addressed to the threat location to the threat location without passing through the computing device (e.g., the botnet mitigation controller server). In various embodiments, the computing device may indicate the threat location as non-malicious. For example, indicating the threat location is non-malicious may include removing the threat location from the listings of threat locations identified by botnet detection tools of the network and/or a third-party threat intelligence services.

Various embodiments may provide solutions to mitigate botnets at a low cost to a network operator, such as an ISP. Various embodiments may enable the diversion and/or blocking of detected communication to malicious C2 servers, thereby stopping a number of types of malicious botnet activities, such as malicious data extraction (e.g., unauthorized financial data extraction, unauthorized health data extraction, unauthorized personal information extraction, etc.), directing computing devices to participate in attacks (e.g., ransomware attacks, malware attacks, zombie attacks, DDoS attacks, etc.), directing computing devices to conduct unauthorized bitcoin mining, etc. Various embodiments may provide solutions to mitigate botnets that have a low network footprint and that may only impact/block Internet traffic destined to C2 servers. Various embodiments may enable the mitigation of botnets without the requirement to add inline network computing devices. Rather, the various embodiments may enable outbound Internet traffic to be diverted to a computing device that is not inline. In this manner, connectivity efficiency problems with adding inline network computing devices may be avoided by the various embodiments. Additionally, various embodiments may enable botnet mitigation that is automated without requiring manual intervention.

Various embodiment methods for mitigating botnets may be implemented in a system comprising one or more different computing devices of a network, such as one or more of a botnet threat detector server, a botnet mitigation controller server, a threat inspection server, and/or a route reflector. Alternatively, various embodiments may be implemented in a single computing device of a network. As one example, various embodiment methods for mitigating botnets may be implemented in a botnet mitigation controller server. As another example, various embodiment method for mitigating botnets may be implemented in a route reflector. In various embodiments, operations to mitigate botnets as discussed herein may be implemented in different virtual machines or other type containers running on one or more processors of the same computing device in a network.

Various examples of different protocols are discussed herein, such as BGP, BGP Flowspec, IPv4, etc. The discussions of specific protocols, such as BGP, BGP Flowspec, IPv4, etc., are provided merely as examples to better illustrate the aspects of the various embodiments and are not intended to limit the various embodiments in any way. Other protocols may be used with the various embodiments, and the other protocols may be substituted in the various examples without departing from the spirit or scope of the invention.

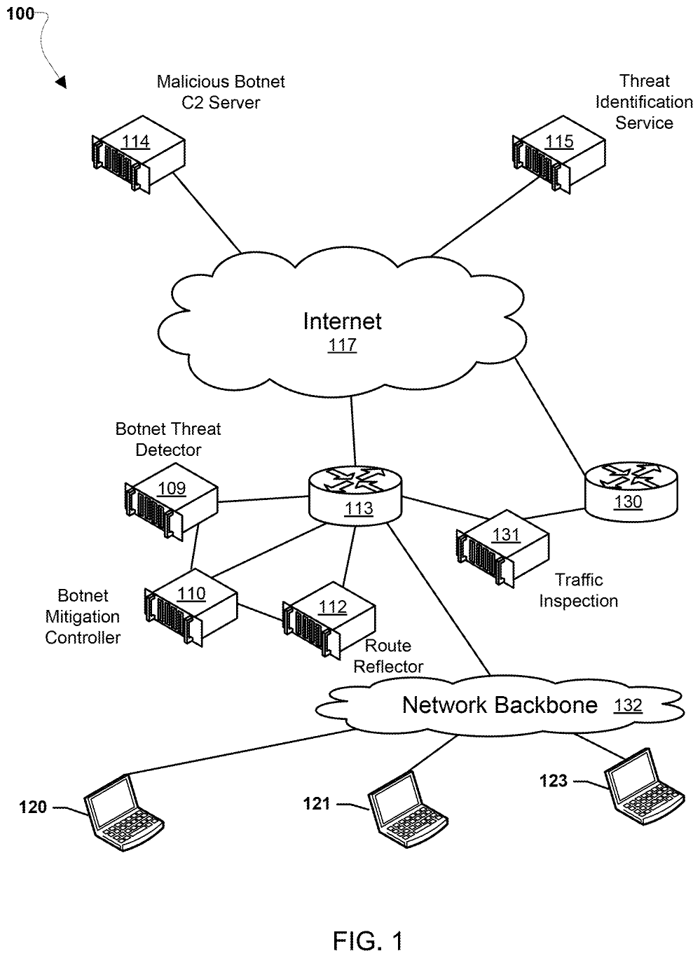

FIG. 1 illustrates an IP network 100 suitable for use with various embodiments. The IP network 100 may include multiple devices, such as routers 113, 130, servers 109, 110, 112, 114, 115, 131, and computing devices 120, 121, 123. While the router 113 is illustrated in FIG. 1 as a single device, the router 113 may be one or more routers of a network operator, such as an ISP. In various embodiments, the router 113 may be a router, such as a customer edge router, backbone router, etc., connecting customer computing devices, such as computing devices 120, 121, 123 to the Internet 117. The router 113 and computing devices 120, 121, 123 may exchange data with one another according to IP protocols via their various connections with one another. The router 113 may be connected to the Internet 117. Via the router 113, the computing devices 120, 121, 123 may send and/or receive data to the Internet 117. In various embodiments, the computing devices may connect to the router 113 via a network backbone 132 including various routers and other network equipment configured to connect the computing devices 120, 121, 123 to the router 113 such that the router 113 and computing devices 120, 121, 123 may exchange data with one another according to IP protocols via their various connections with one another.

In various embodiments, the server 109 may be a botnet threat detector server 109. The router 113 and botnet threat detector server 109 may exchange data with one another according to IP protocols via their various connections with one another. The botnet threat detector server 109 may be configured to detect outbound Internet traffic associated with a threat location. For example, the botnet threat detector server 109 may monitor DNS lookups performed by the computing devices 120, 121, 123 by tapping netflows or by monitoring DNS lookup logs. The botnet threat detector server 109 may be configured to identify outbound Internet traffic associated with threat locations.

In various embodiments, the server 110 may be a botnet mitigation controller server 110. The router 113, the botnet threat detector server 109, and botnet mitigation controller server 110 may exchange data with one another according to IP protocols via their various connections with one another. The botnet mitigation controller server 110 may receive indications of outbound Internet traffic associated with a threat location from the botnet threat detector server 109. In various embodiments, the botnet mitigation controller server 110 may be continually listening for IP addresses of known (or suspected) threat locations in DNS lookups performed by the computing devices 120, 121, 123 and indicated by the botnet threat detector server 109. As a specific example, the botnet mitigation controller server 110 may run a Python script which is continuously listening for the IP addresses of known (or suspected threat locations in DNS lookups. The botnet mitigation controller server 110 may be configured to divert Internet traffic outbound to a threat location and inspect the diverted Internet traffic to determine whether the diverted Internet traffic is malicious or not. In various embodiments, diverting Internet traffic for the threat location may include generating and sending a BGP update, such as a BGP Flowspec update, indicating a more specific BGP route for the threat location, e.g., a /32 route for the threat location, to a computing device of the network, such as server 112. For example, the BGP update may be a BGP Flowspec updated with one or more features including a destination and/or source IP address (or subnet), IP protocol, rate limiting factor, source and/or destination ports, next hop address setting, packet drop indication, etc. In various embodiments, the server 112 may be route reflector 112 configured to learn new routes and deploy them across a network, such as an ISP's network, via various protocols, such as BGP. The router 113, the botnet mitigation controller server 110, and the route reflector 112 may exchange data with one another according to IP protocols via their various connections with one another. The route reflector 112 may be configured to push a BGP update (e.g., BGP Flowspec update) indicating a more specific BGP route for the threat location, e.g., a /32 route for the threat location, to the router 113.

In various embodiments, the server 115 may be a threat identification service server 115 connected to the Internet 117. The threat identification service server 115 may be a server of a third-party threat intelligence service providing listings of known (or suspected) malicious C2 servers via the Internet 117 to the botnet mitigation server 110.

The server 114 may be a malicious botnet C2 server 114 connected to the Internet 117. The IP address and/or domain of the malicious botnet C2 server 114 may be included in the listings of known (or suspected) malicious C2 servers at the botnet threat detector server 109. Upon one or more of the computing devices 120, 121, 123 being infected with malware causing that infected computing device 120, 121, 123 to participate in a malicious botnet, the infected computing device 120, 121, 123 may attempt to communicate with the malicious botnet C2 server 114 over the Internet 117. The infected computing device 120, 121, 123 may attempt to resolve a domain name associated with the malicious botnet C2 server 114 to the IP address of the malicious botnet C2 server 114 through a DNS lookup. The DNS lookup associated with the IP address of the malicious botnet C2 server 114 may be identified by the botnet threat detector server 109 and reported to the botnet mitigation controller server 110. The botnet mitigation controller server 110 may divert outbound Internet traffic for the malicious botnet C2 server 114 to a traffic inspection server 131 by programmatically sending a BGP update indicating a more specific BGP route for the IP address of the malicious botnet C2 server 114, e.g., a /32 route for the IP address of the malicious botnet C2 server 114, to the route reflector 112. The route reflector 112 may push the BGP update indicating a more specific BGP route for the IP address of the malicious botnet C2 server 114, e.g., a /32 route for the IP address of the malicious botnet C2 server 114, to the router 113. In this manner, when the infected computing device 120, 121, 123 sends outbound Internet traffic addressed to the IP address of the malicious botnet C2 server 114 to the router 113, the router 113 may send the Internet traffic addressed to the IP address of the malicious botnet C2 server 114 to the traffic inspection server 131. In various embodiments, the server 131 may be a traffic inspection server 131, such as a firewall device, deep packet inspection device, etc. The router 113 and the traffic inspection server 131 may exchange data with one another according to IP protocols via their various connections with one another. The traffic inspection server 131 may inspect the diverted outbound Internet traffic addressed to the IP address of the malicious botnet C2 server 114.

In response to determining that the diverted outbound Internet traffic addressed to the IP address of the malicious botnet C2 server 114 is actually malicious, the traffic inspection server 131 may handle the diverted outbound Internet traffic according to a security setting, such as dropping the packets of the traffic, routing the traffic to a firewall for further handling, etc. In this manner, malicious outbound Internet traffic addressed to the IP address of the malicious botnet C2 server 114 may never actually reach the malicious botnet C2 server 114, thereby mitigating the malicious botnet associated with the malicious botnet C2 server 114. In response to determining that the diverted outbound Internet traffic addressed to the IP address of the malicious botnet C2 server 114 is not malicious, the traffic inspection server 131 may route the diverted outbound Internet traffic to its original destination via a router 130. The router 130 may be a router connecting the traffic inspection server 131 to the Internet 117. While the router 130 is illustrated in FIG. 1 as a single device, the router 130 may be one or more routers of a network operator, such as an ISP. In various embodiments, the router 130 may be a router, such as a customer edge router, backbone router, etc., connecting the traffic inspection server 131 to the Internet 117. The router 130 and traffic inspection server 131 may exchange data with one another according to IP protocols via their various connections with one another. The router 130 may be connected to the Internet 117. Via the router 130, the traffic inspection server 131 may send the determined to be not malicious Internet traffic to the Internet 117.

In various embodiments, the botnet threat detector server 109, the botnet mitigation controller server 110, route reflector 112, traffic inspection server 131, and router 130 may not be in-line computing devices from the perspective of the computing devices 120, 121, 123 and Internet 117 as Internet traffic from/to the computing devices 120, 121, 123 and Internet 117 may be exchanged via the router 113 without being required to flow through the botnet threat detector server 109, the botnet mitigation controller server 110, route reflector 112, traffic inspection server 131, and/or router 130. By comparison, the router 113 may be considered an in-line computing from the perspective of the computing devices 120, 121, 123 and Internet 117 as Internet traffic from/to the computing devices 120, 121, 123 and Internet 117 must flow, at least in part, through the router 113.

While illustrated as separate computing devices, the botnet threat detector server 109, the botnet mitigation controller server 110, route reflector 112, traffic inspection server 131, and router 130 being separate computing devices is only one example configuration of the network 100. In other configurations, one or more of the botnet threat detector server 109, the botnet mitigation controller server 110, route reflector 112, traffic inspection server 131, and/or router 130 may be combined into the same computing device.

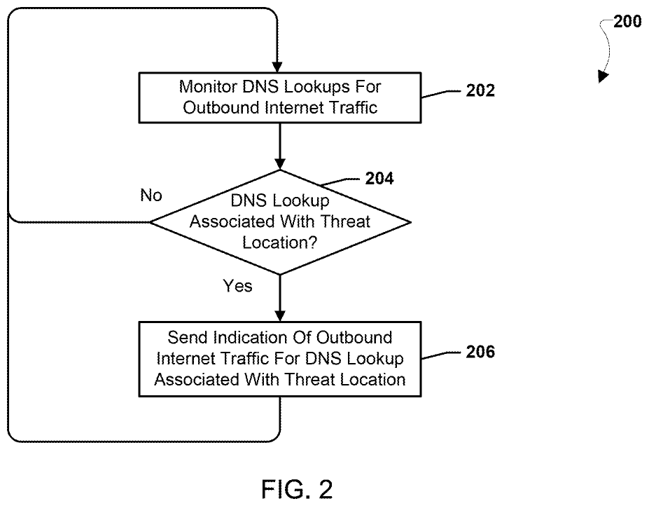

FIG. 2 illustrates an embodiment method 200 for identifying potentially malicious Internet traffic. With reference to FIGS. 1-2, in various embodiments the operations of method 200 may be performed by a computing device of a network, such as botnet threat detector server 109, botnet mitigation controller server 110, and/or route reflector 112.

In block 202, the computing device may monitor DNS lookups for outbound Internet traffic. For example, the computing device may monitor DNS lookups by tapping netflows in a network or by monitoring DNS lookup logs.

In determination block 204, the computing device may determine whether a DNS lookup is associated with a threat location. As a specific example, the computing device may run a Python script which is continuously listening for the IP addresses of known (or suspected) threat locations in DNS lookups to determine a DNS lookup is associated with a threat location. A threat location may be an Internet destination associated with a malicious C2 server, such as an Internet Protocol (IP) address of a malicious C2 server, a domain associated with a malicious C2 server, etc. Threat locations may be identified by botnet detection tools of the network and/or a third-party threat intelligence service providing listings of known (or suspected) malicious C2 servers, such as listings of known (or suspected) malicious C2 server IP addresses, listings of known (or suspected) malicious C2 server domains, etc. Listings of known (or suspected) threat locations may be updated as information about malicious C2 servers associated with botnets is obtained from botnet detection tools of the network and/or a third-party threat intelligence service. The listings of known (or suspected) threat locations may operate as a blacklist for the network causing any outbound Internet traffic destined for the listed threat locations to be diverted. The listings of known (or suspected) threat locations may be changed and/or modified by the network operator, such as to add, remove, and/or modify threat locations. For example, the computing device may compare the IP addresses or domains in the DNS lookups to listings of threat locations identified by botnet detection tools of the network and/or a third-party threat intelligence services to determine whether the DNS lookups are associated with a threat location. DNS lookups associated with a threat location may indicate that a computing device of the network is attempting to communicate to that threat location over the Internet and will send Internet traffic to that threat location. In response to determining that a DNS lookup is not associated with a threat location (i.e., determination block 204=“No”), the computing device may continue to monitor DNS lookups for outbound Internet traffic in block 202.

In response to determining that a DNS lookup is associated with a threat location (i.e., determination block 204=“Yes”), the computing device may send an indication of outbound Internet traffic for the DNS lookup associated with the threat location in block 206. For example, the computing device may send an indication of outbound Internet traffic for the DNS lookup associated with the threat location to a botnet mitigation controller server. The indication of the outbound Internet traffic for the DNS lookup associated with the threat location may be a message indicating that a computing device of a network is attempting to send outbound Internet traffic from the network to an IP address and/or a domain associated with a threat location. The indication of the outbound Internet traffic for the DNS lookup associated with the threat location may include the IP address and/or domain of the threat location.

In response to sending the indication of outbound Internet traffic associated with the threat location, the computing device may continue to monitor DNS lookups for outbound Internet traffic in block 202. In this manner, the computing device may continually monitor the network for outbound Internet traffic associated with threat locations.

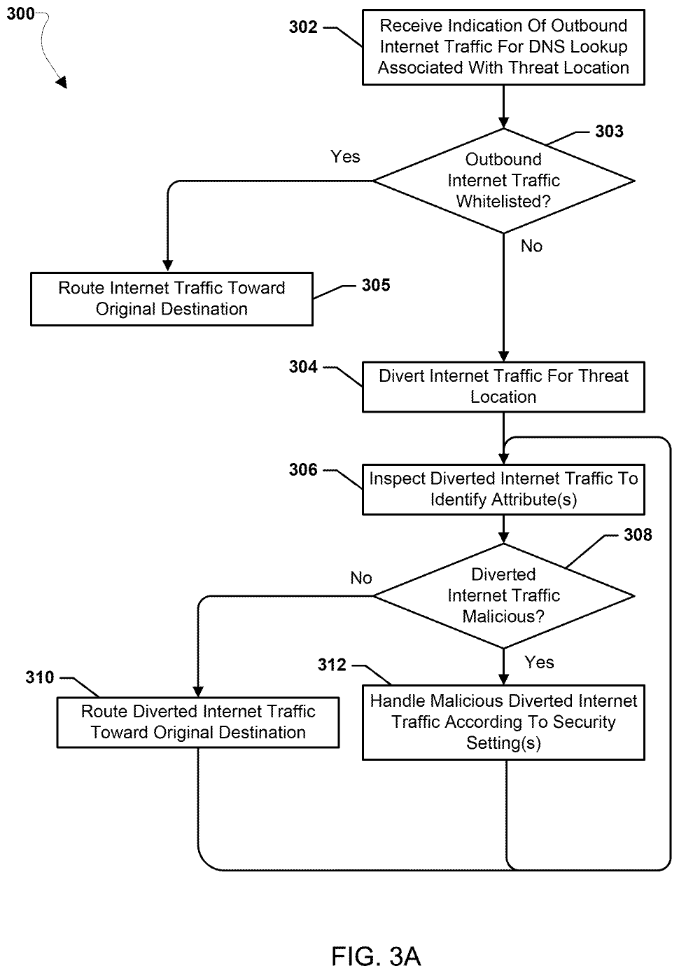

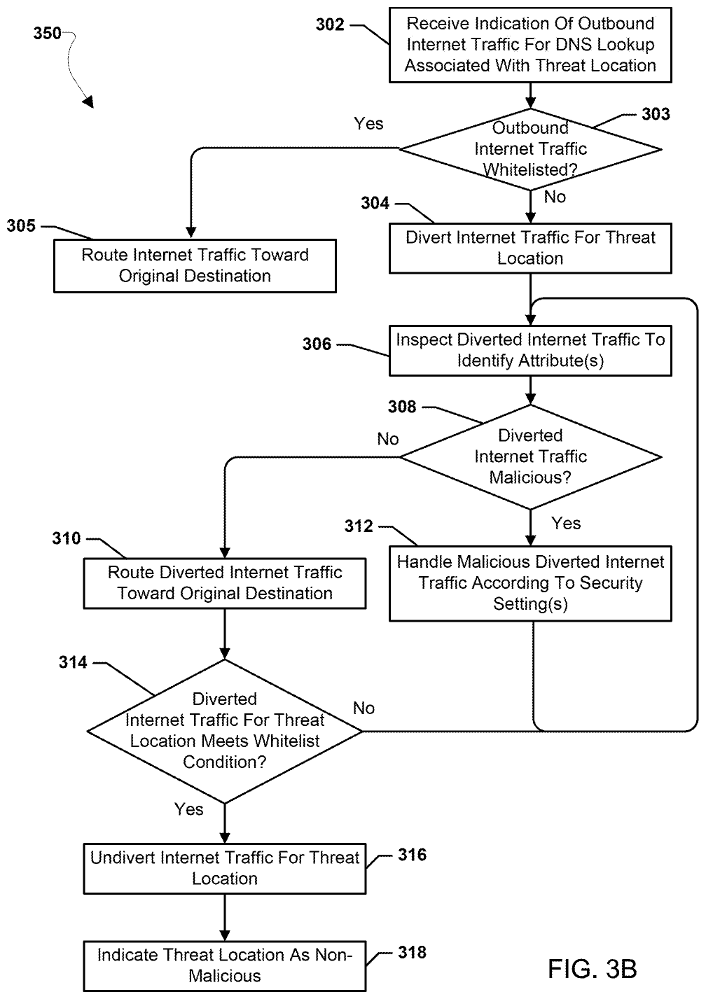

FIG. 3A illustrates an embodiment method 300 for mitigating botnets. With reference to FIGS. 1-3A, in various embodiments the operations of method 300 may be performed by a computing device of a network, such as botnet threat detector server 109, botnet mitigation controller server 110, route reflector 112, and/or traffic inspection server 131. In various embodiments, the operations of method 300 may be performed in conjunction with the operations of method 200 (FIG. 2).

In block 302, the computing device may receive an indication of outbound Internet traffic for a DNS lookup associated with a threat location. For example, the computing device may receive an indication of outbound Internet traffic for a DNS lookup associated with a threat location from a botnet threat detector server. The indication of the outbound Internet traffic for the DNS lookup associated with the threat location may be a message indicating that a computing device of a network is attempting to send outbound Internet traffic from the network to an IP address and/or a domain associated with a threat location. The indication of the outbound Internet traffic for the DNS lookup associated with the threat location may include the IP address and/or domain of the threat location.

In block 303, the computing device may determine whether the outbound Internet traffic is whitelisted. For example, the computing device may compare the IP address and/or domain for the destination of the outbound Internet traffic to a listing of pre-cleared IP addresses and/or domains that not malicious. The whitelist may be a listing of known safe IP addresses and/or domains that may be predetermined to not be associated with threat locations. In this manner, the computing device may check whether a third-party system, such as threat identification service server 115, may have inadvertently flagged an IP address and/or domain as malicious. In response to the outbound traffic being whitelisted (i.e., determination block 303=“Yes”), the computing device may route Internet traffic toward its original destination in block 305. In this manner, Internet traffic that is whitelisted may not be diverted from its original routing path.

In response to the outbound traffic not being whitelisted (i.e., determination block 303=“No”) in block 304 the computing device may divert Internet traffic for the threat location. In various embodiments, diverting Internet traffic for the threat location may include generating and sending a BGP update indicating a more specific BGP route for the threat location, e.g., a /32 route for the threat location, to a route reflector of the network. The BGP update indicating a more specific BGP route for the threat location may indicate a computing device (e.g., the botnet mitigation controller server, traffic inspection server, etc.) that is in the path to use for outbound Internet traffic addressed to the threat location. In various embodiments, the BGP update indicating a more specific BGP route for the threat location may be a BGP Flow Specification (BGP Flowspec) update. The route reflector may push the BGP update indicating a more specific BGP route for the threat location, e.g., a /32 route for the threat location, to routers in the network, such as customer edge routers in the network, backbone network routers, other routers, etc. In response to receiving the BGP update indicating a more specific BGP route for the threat location, e.g., a /32 route for the threat location, the routers in the network, such as customer edge routers, may route all outbound Internet traffic from customer computing devices addressed to the threat location to the computing device (e.g., traffic inspection server, etc.). In this manner, all outbound Internet traffic from customer computing devices addressed to the threat location may be diverted to the computing device (e.g., the traffic inspection server, etc.).

In block 306, the computing device may inspect diverted Internet traffic to identify one or more attributes of the diverted Internet traffic. In various embodiments, inspecting the diverted Internet traffic to identify one or more attributes of the diverted Internet traffic may include performing deep packet inspection on the diverted Internet traffic. The attributes of the diverted Internet traffic identified by the inspection may include the type of data in the packets of the diverted Internet traffic, the format of data in the packets of the diverted Internet traffic, values of data in the packets of the diverted Internet traffic, etc.

In determination block 308, the computing device may determine whether the diverted Internet traffic is malicious. In various embodiments, the computing device may determine whether the diverted Internet traffic is malicious based at least in part on the identified one or more attributes of the diverted Internet traffic. For example, the computing device may compare the one or more attributes of the diverted Internet traffic to attributes of known malicious botnet traffic and in response to the one or more attributes matching an attribute of known malicious botnet traffic may determine that the diverted Internet traffic is malicious. As another example, the computing device may compare the one or more attributes of the diverted Internet traffic to attributes of known malicious botnet traffic and in response none of the attributes matching an attribute of known malicious botnet traffic may determine that the diverted Internet traffic is not malicious.

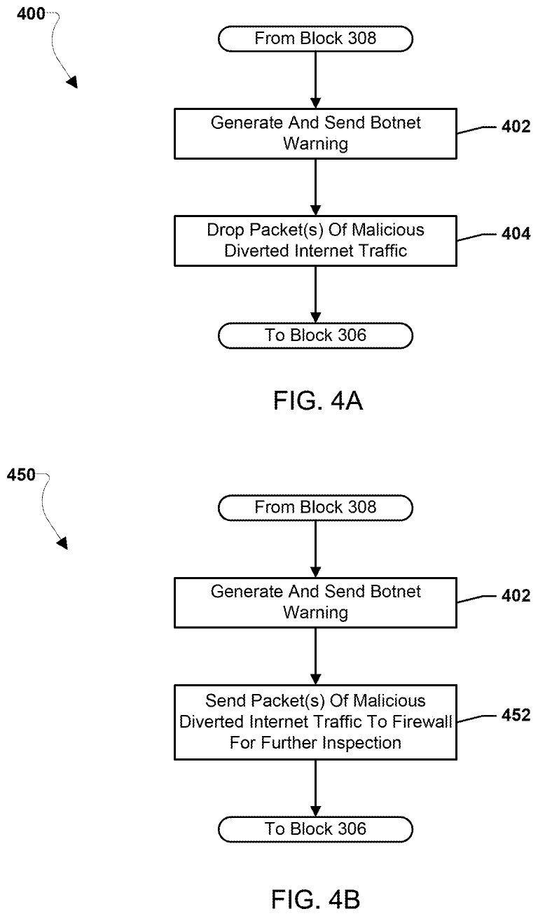

In response to determining that the diverted Internet traffic is malicious (i.e., determination block 308=“Yes”), the computing device may handle the malicious diverted Internet traffic according to one or more security settings in block 312. For example, the computing device may handle the malicious diverted Internet traffic according to the operations of methods 400 and/or 450 described with reference to FIGS. 4A and 4B, respectively. In response to handling the malicious diverted Internet traffic according to one or more security settings, the computing device may continue to inspect diverted Internet traffic in block 306.

In response to determining that the diverted Internet traffic is not malicious (i.e., determination block 308=“No”), the computing device may route the diverted Internet traffic toward its original destination in block 310. As some IP addresses, especially IP version 4 (IPv4) addresses, may be shared by multiple computing devices, not all Internet traffic destined for a suspected threat location may actually be malicious. As such, in various embodiments, when the Internet traffic is determined to not be malicious, the Internet traffic may be routed toward its original destination.

Upon handling the malicious diverted Internet traffic in block 310 and/or routing the diverted Internet traffic toward its original destination in block 310, the computing device may proceed to block 306 to inspect diverted Internet traffic.

FIG. 3B illustrates an embodiment method 350 for mitigating botnets. With reference to FIGS. 1-3B, in various embodiments the operations of method 350 may be performed by a computing device of a network, such as botnet threat detector server 109, botnet mitigation controller server 110, route reflector 112, and/or traffic inspection server 131. In various embodiments, the operations of method 350 may be performed in conjunction with the operations of method 200 (FIG. 2).

In blocks 302, 304, 306, 308, 310, and 312, the computing device may perform like numbered operations of method 300 described with reference to FIG. 3A. Upon handling the malicious diverted Internet traffic in block 310 and/or routing the diverted Internet traffic toward its original destination in block 310, in determination block 314, the computing device may determine whether the diverted Internet traffic for the threat location meets a whitelist condition. For example, a whitelist condition may be a number of times that diverted Internet traffic for a threat location is determined to not be malicious. Diverted Internet traffic for a threat location being found malicious a selected number of times may indicate that the threat location is not actually malicious. In various embodiments, determining whether the diverted Internet traffic for the threat location meets a whitelist condition may be optional as all systems may not enable threat locations to be delisted. In response to determining that the diverted Internet traffic does not meet the whitelist condition (i.e., determination block 314=“No”), the computing device may continue to inspect diverted Internet traffic in block 306.

In response to determining that the diverted Internet traffic does meet the whitelist condition (i.e., determination block 314=“Yes”), the computing device may un-divert Internet traffic for the threat location in block 316. In various embodiments, undiverting Internet traffic for the threat location may include generating and sending a BGP withdraw (e.g., a BGP Flowspec withdraw, etc.) removing the more specific BGP route for the threat location previously added for the threat location, e.g., canceling the /32 route for the threat location, to a route reflector of the network. The BGP withdraw canceling the more specific BGP route for the threat location may effectively remove the computing device itself (e.g., the botnet mitigation controller server, etc.) from the path to the threat location. The route reflector may push the BGP withdraw removing the more specific BGP route for the threat location to routers in the network, such as customer edge routers in the network. In response to receiving the BGP withdraw removing the more specific BGP route for the threat location the routers in the network, such as customer edge routers, may route all outbound Internet traffic from customer computing devices addressed to the threat location to the threat location without passing through the computing device (e.g., the botnet mitigation controller server). In various embodiments, a BGP withdraw, such as a BGP Flowspec withdraw may also be added when the IP address of a malicious server is removed from the third-party threat intelligence lists and/or when the malicious server is no longer marked as active by a botnet detection server.

In block 318, the computing device may indicate the threat location as non-malicious. For example, indicating the threat location is non-malicious may include removing the threat location from the listings of threat locations identified by botnet detection tools of the network and/or a third-party threat intelligence services.

FIG. 4A illustrates an embodiment method 400 for handling malicious diverted Internet traffic according to one or more security settings. With reference to FIGS. 1-4A, in various embodiments the operations of method 400 may be performed by a computing device of a network, such as botnet threat detector server 109, botnet mitigation controller server 110, route reflector 112, and/or traffic inspection server 131. In various embodiments, the operations of method 400 may be performed in conjunction with the operations of method 300 (FIG. 3A) and/or 350 (FIG. 3B) to handle malicious diverted Internet traffic according to one or more security settings in block 312.

In response to determining that the diverted Internet traffic is malicious (i.e., determination block 308 of method 300, 350=“Yes”), the computing device may generate and send a botnet warning in block 402. A botnet warning may be a message indicating that malware has infected one or more computing device of a network, such as an ISP, causing the computing device to operate in a malicious botnet. The botnet warning may be sent to one or more security services of a network operator and/or to the computing devices that are infected.

In block 404, the computing device may drop one or more packets of the malicious Internet traffic and proceed to block 306 of method 300. Dropping one or more of the packets of the malicious Internet traffic may cause the packets to never reach their intended destination, thereby thwarting and/or otherwise mitigating the malicious botnet.

FIG. 4B illustrates an embodiment method 450 for handling malicious diverted Internet traffic according to one or more security settings. With reference to FIGS. 1-4B, in various embodiments the operations of method 450 may be performed by a computing device of a network, such as botnet threat detector server 109, botnet mitigation controller server 110, route reflector 112, and/or traffic inspection server 131. In various embodiments, the operations of method 400 may be performed in conjunction with the operations of method 300 (FIG. 3A) and/or 350 (FIG. 3B) to handle malicious diverted Internet traffic according to one or more security settings in block 312.

In response to determining that the diverted Internet traffic is malicious (i.e., determination block 308 of method 300, 350=“Yes”), in block 402 the computing device may perform operations of like numbered block of method 400 as discussed with reference to FIG. 4A to generate and send a botnet warning.

In block 452, the computing device may send one or more packets of the malicious diverted Internet traffic to a firewall for further inspection and proceed to block 306 of method 300. Sending the malicious diverted Internet traffic to a firewall may enable further security operations to be applied to the malicious diverted Internet traffic, thereby thwarting and/or otherwise mitigating the malicious botnet.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 200, 300, 350, 400, and 450 may be substituted for or combined with one or more operations of the methods 200, 300, 350, 400, and 450, and vice versa.

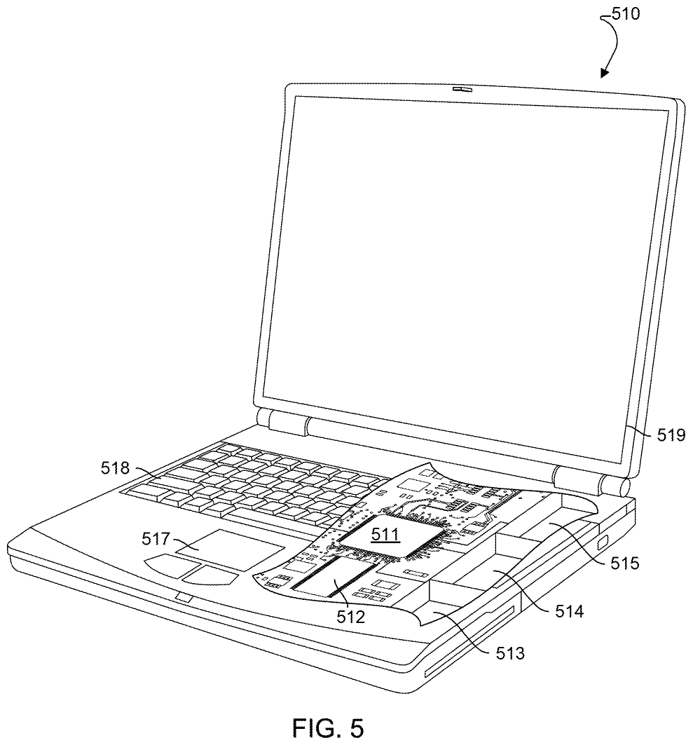

FIG. 5 is a component diagram of an example computing device suitable for use with various embodiments. The various embodiments (including, but not limited to, embodiments discussed above with reference to FIGS. 1-4B) described above may also be implemented within a variety of computing devices, such as a laptop computer 510 as illustrated in FIG. 5. Many laptop computers include a touch pad touch surface 517 that serves as the computer's pointing device, and thus may receive drag, scroll, and flick gestures similar to those implemented on mobile computing devices equipped with a touch screen display and described above. A laptop computer 510 will typically include a processor 511 coupled to volatile memory 512 and a large capacity nonvolatile memory, such as a disk drive 513 of Flash memory. The laptop computer 510 may also include a floppy disc drive 514 and a compact disc (CD) drive 515 coupled to the processor 511. The laptop computer 510 may also include a number of connector ports coupled to the processor 511 for establishing data connections or receiving external memory devices, such as a USB or FireWire® connector sockets, or other network connection circuits (e.g., interfaces) for coupling the processor 511 to a network. In a notebook configuration, the computer housing may include the touchpad 517, the keyboard 518, and the display 519 all coupled to the processor 511. Other configurations of the computing device may include a computer mouse or trackball coupled to the processor (e.g., via a USB input) as are well known, which may also be used in conjunction with the various embodiments.

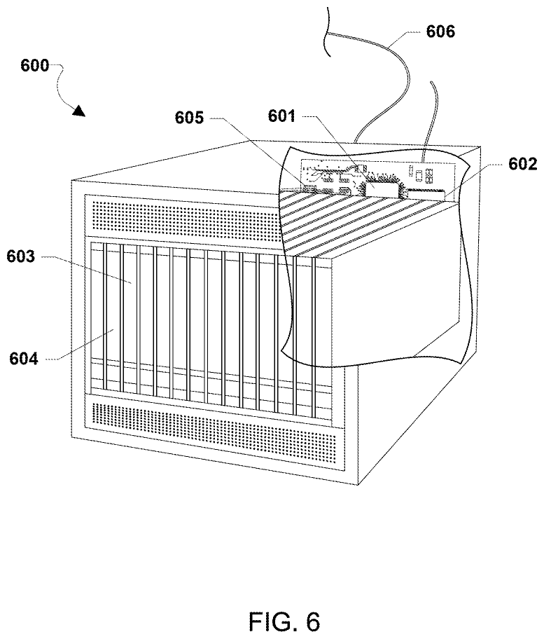

Various embodiments (including, but not limited to, embodiments discussed above with reference to FIGS. 1-4B) may be implemented on any of a variety of commercially available server devices, such as the server device 600 illustrated in FIG. 6. Such a server device 600 may include a processor 601 coupled to volatile memory 602 and a large capacity nonvolatile memory, such as a disk drive 603. The server device 600 may also include a floppy disc drive, compact disc (CD) or DVD disc drive 604 coupled to the processor 601. The server device 600 may also include network access ports 606 coupled to the processor 601 for establishing data connections with a network connection circuit 605 and a communication network (e.g., IP network) coupled to other communication system network elements.

The processors 511, 601 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 511, 601. The processors 511, 601 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 511, 601 including internal memory or removable memory plugged into the device and memory within the processors 511, 601 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of mitigating botnets in a network, comprising:
inspecting, by a computing device of the network, diverted Internet traffic associated with a threat location to identify one or more attributes of the diverted Internet traffic, wherein the diverted Internet traffic is outbound Internet traffic diverted in response to an indication that the outbound Internet traffic is associated with the threat location;
determining, by the computing device, whether the diverted Internet traffic is malicious based at least in part on the identified one or more attributes; and
handling, by the computing device, the diverted Internet traffic according to one or more security settings in response to determining that the diverted Internet traffic is malicious.

2. The method of claim 1, further comprising:
routing, by the computing device, the diverted Internet traffic toward the diverted Internet traffic's original destination in response to determining that the diverted Internet traffic is not malicious.

3. The method of claim 1, wherein inspecting the diverted Internet traffic to identify the one or more attributes of the diverted Internet traffic comprises performing, by the computing device, deep packet inspection on the diverted Internet traffic.

4. The method of claim 1, wherein the threat location is an Internet Protocol (IP) address.

5. The method of claim 1, wherein the diverted Internet traffic associated with the threat location is diverted in response to a Border Gateway Protocol (BGP) update to one or more routers of the network indicating a path to use for all Internet traffic originating in the network addressed to the threat location.

6. The method of claim 1, wherein the indication that the outbound Internet traffic is associated with the threat location is an indication that a domain name service lookup from another computing device of the network was associated with the threat location.

7. The method of claim 1, wherein handling the diverted Internet traffic according to one or more security settings comprises dropping one or more packets of the diverted Internet traffic.

8. The method of claim 1, wherein handling the diverted Internet traffic according to one or more security settings comprises sending one or more packets of the diverted Internet traffic to a firewall for further inspection.

9. A computing device, comprising:
a processor configured with processor-executable instructions to perform operations comprising:
inspecting diverted Internet traffic associated with a threat location to identify one or more attributes of the diverted Internet traffic, wherein the diverted Internet traffic is outbound Internet traffic diverted in response to an indication that the outbound Internet traffic is associated with the threat location;
determining whether the diverted Internet traffic is malicious based at least in part on the identified one or more attributes; and
handling the diverted Internet traffic according to one or more security settings in response to determining that the diverted Internet traffic is malicious.

10. The computing device of claim 9, wherein the processor-executable instructions are configured to cause the processor to perform operations further comprising:
routing the diverted Internet traffic toward the diverted Internet traffic's original destination in response to determining that the diverted Internet traffic is not malicious.

11. The computing device of claim 9, wherein the processor-executable instructions are configured to cause the processor to perform operations such that inspecting the diverted Internet traffic to identify the one or more attributes of the diverted Internet traffic comprises performing deep packet inspection on the diverted Internet traffic.

12. The computing device of claim 9, wherein the processor-executable instructions are configured to cause the processor to perform operations such that the threat location is an Internet Protocol (IP) address.

13. The computing device of claim 9, wherein the processor-executable instructions are configured to cause the processor to perform operations such that the diverted Internet traffic associated with the threat location is diverted in response to a Border Gateway Protocol (BGP) update to one or more routers of a network indicating a path to use for all Internet traffic originating in the network addressed to the threat location.

14. The computing device of claim 9, wherein the processor-executable instructions are configured to cause the processor to perform operations such that the indication that the outbound Internet traffic is associated with the threat location is an indication that a domain name service lookup from another computing device of a network was associated with the threat location.

15. The computing device of claim 9, wherein the processor-executable instructions are configured to cause the processor to perform operations such that handling the diverted Internet traffic according to one or more security settings comprises dropping one or more packets of the diverted Internet traffic.

16. The computing device of claim 9, wherein the processor-executable instructions are configured to cause the processor to perform operations such that handling the diverted Internet traffic according to one or more security settings comprises
sending one or more packets of the diverted Internet traffic to a firewall for further inspection.

17. A non-transitory processor readable medium having stored thereon processor-executable instructions configured to cause a processor to perform operations comprising:
inspecting diverted Internet traffic associated with a threat location to identify one or more attributes of the diverted Internet traffic, wherein the diverted Internet traffic is outbound Internet traffic diverted in response to an indication that the outbound Internet traffic is associated with the threat location;
determining whether the diverted Internet traffic is malicious based at least in part on the identified one or more attributes; and
handling the diverted Internet traffic according to one or more security settings in response to determining that the diverted Internet traffic is malicious.

18. The non-transitory processor readable medium of claim 17, wherein the stored processor-executable instructions are configured to cause a processor to perform operations further comprising:
routing the diverted Internet traffic toward the diverted Internet traffic's original destination in response to determining that the diverted Internet traffic is not malicious.

19. The non-transitory processor readable medium of claim 17, wherein the stored processor-executable instructions are configured to cause a processor to perform operations such that inspecting the diverted Internet traffic to identify the one or more attributes of the diverted Internet traffic comprises performing deep packet inspection on the diverted Internet traffic.

20. The non-transitory processor readable medium of claim 17, wherein the stored processor-executable instructions are configured to cause a processor to perform operations such that the threat location is an Internet Protocol (IP) address.

21. The non-transitory processor readable medium of claim 17, wherein the stored processor-executable instructions are configured to cause a processor to perform operations the diverted Internet traffic associated with the threat location is diverted in response to a Border Gateway Protocol (BGP) update to one or more routers of a network indicating a path to use for all Internet traffic originating in the network addressed to the threat location.

22. The non-transitory processor readable medium of claim 17, wherein the stored processor-executable instructions are configured to cause a processor to perform operations such that the indication that the outbound Internet traffic is associated with the threat location is an indication that a domain name service lookup from another computing device of a network was associated with the threat location.

23. The non-transitory processor readable medium of claim 17, wherein the stored processor-executable instructions are configured to cause a processor to perform operations handling the diverted Internet traffic according to one or more security settings comprises dropping one or more packets of the diverted Internet traffic.

24. The non-transitory processor readable medium of claim 17, wherein the stored processor-executable instructions are configured to cause a processor to perform operations such that handling the diverted Internet traffic according to one or more security settings comprises sending one or more packets of the diverted Internet traffic to a firewall for further inspection.
